(19) United States
(12) Patent Application Publication
(10) Pub. No.: US 2016/0092887 A1
(43) Pub. Date: Mar. 31, 2016

(54) APPLICATION LICENSE DISTRIBUTION AND MANAGEMENT

(71) Applicant: AirWatch LLC, Atlanta, GA (US)

(72) Inventors: Pratik Jagad, Atlanta, GA (US); Manmeet Kaur, Atlanta, GA (US)

(21) Appl. No.: 14/502,654

(22) Filed: Sep. 30, 2014

(51) Int. Cl. G06Q 30/00; G06F 21/10

(52) U.S. Cl. CPC G06Q 30/018; G06F 21/105; G06Q 2220/18

(57) ABSTRACT

Embodiments of the disclosure are related to initiating deployment of applications to client devices in an enterprise environment. Embodiments of the disclosure interoperate with an application distribution environment from which applications are deployed to client devices and from which licenses for the applications may be obtained in bulk by the enterprise environment. Licenses can be assigned to user groups within the enterprise and then assigned to users who desire or require a particular application from the application distribution environment.

### CROSS-REFERENCE TO RELATED APPLICATIONS

The present application claims priority to U.S. Provisional Application No. 61/943,469 entitled Optimized Application License Distribution and Management, which was filed on Feb. 23, 2014 and is incorporated by reference herein in its entirety.

### BACKGROUND

Client devices, such as smartphones, tablet computers, and the like, may execute applications that perform various functions. The applications may be obtained from a repository where the applications are stored and distributed for any number of users. In order to obtain and/or install these applications, users may need to obtain a license to do so from the repository and/or the application.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIGS. 2-3 are example user interfaces associated with various embodiments of the present disclosure.

FIGS. 4-5 are example user interfaces rendered by a client device associated with various embodiments of the present disclosure.

FIG. 6 is a flowchart illustrating one example of functionality implemented as portions of the license allocation application executed in a computing environment in the networked environment of FIG. 1 according to various embodiments of the present disclosure.

FIG. 7 is a schematic block diagram that provides one example illustration of a computing environment employed in the networked environment of FIG. 1 according to various embodiments of the present disclosure.

### DETAILED DESCRIPTION

The present disclosure is directed towards systems and methods for facilitating the management of digital application licenses associated with applications that are installed on users' devices within an enterprise system. Users in an enterprise environment can be provided with a computing device, such as a smartphone, tablet device, a general purpose computing device, or other computing device. Systems administrators are often tasked with facilitating the installation of applications on users' devices that users may need or desire for various purposes. In some scenarios, applications and updates to these applications are housed in application repositories that are potentially managed by third parties, or entities that are external to or distinct from the enterprise. For example, an application repository may comprise a marketplace that can be accessed via an application that is installed upon a client device of a user, such as a pre-installed application store client that is installed on a smartphone, tablet device, or other computing device.

A client device may be owned outright by a user, or the user may be issued (permitted to use) the client device if owned by an enterprise. In either case, a systems administrator for the enterprise may want to make a particular application available to the user and obtain a set of digital application licenses from an application repository for the particular application. The licenses can then be issued to users designated by the systems administrator. These digital application licenses may be obtained on volume licensing terms from the application repository and then assigned by an enterprise to its users as the enterprise sees fit. Accordingly, embodiments of the system and method described herein facilitate assignment of licenses for applications obtained from an application repository to client devices that may be managed by the enterprise or be managed by users who have enrolled their devices to receive applications via the enterprise under a volume purchasing plan that the enterprise may have in place with the application repository.

A systems administrator may assign licenses for a particular application to various groups of users within an enterprise. For example, users may be grouped into different user groups based upon the user's role within an enterprise, a location of the user, a labor category of the user, or other attribute of a user. Licenses can then be assigned to a particular user when a request to deploy or transmit the application to a client device of the user is received and where the license is obtained from a pool of licenses that are assigned to a group with which the user is associated. In one embodiment, an optimal user group is identified from which a license may be obtained for assignment to the user, wherein the optimal user group is identified based at least in part on an optimality parameter. An optimality parameter can include a priority that is specified by an administrator. For example, a user may be assigned to multiple user groups that are allocated licenses for an application. Accordingly, a priority can be assigned to user groups of which a user is a member such that a license for an application for a user is obtained from an allocation of a higher priority user group before a lower priority user group.

As another example, an optimality parameter can also include a cost factor associated with an application. In some scenarios, an application can be associated with varying levels of cost depending upon the user group to which a license is allocated. Accordingly, the optimality parameter can specify that a license for an application can be obtained from a user group having the lowest cost license for the application.

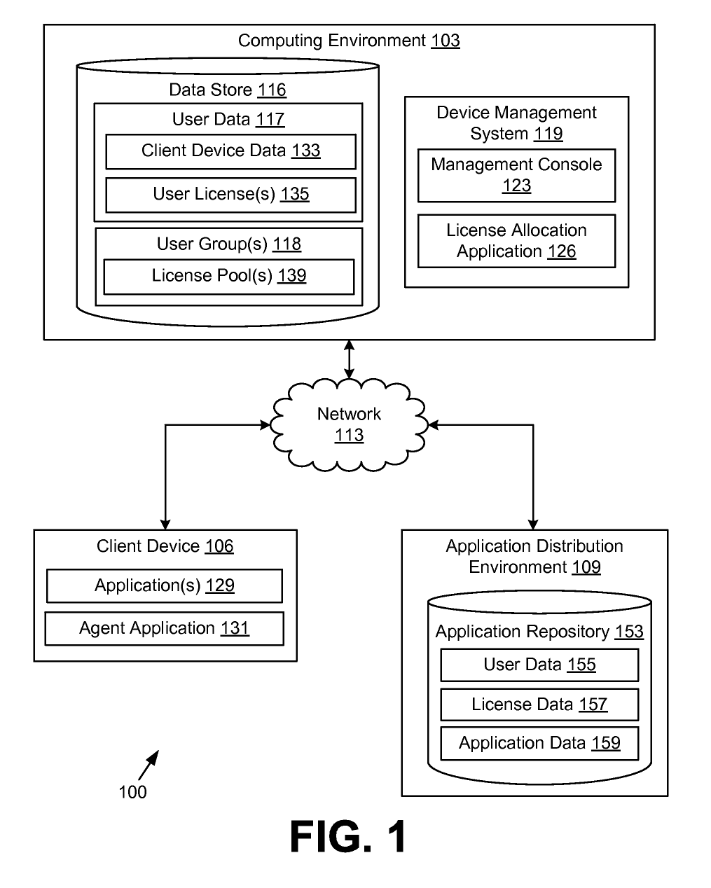

With reference to FIG. 1, shown is a networked environment 100 according to various embodiments. The networked environment 100 includes a computing environment 103, a client device 106, and an application distribution environment 109 which are in data communication with each other via a network 113. The network 113 includes, for example, the Internet, one or more intranets, extranets, wide area networks (WANs), local area networks (LANs), wired networks, wireless networks, other suitable networks, or any combination of two or more such networks. For example, such networks may comprise satellite networks, cable networks, Ethernet networks, telephony networks, and other types of networks.

The computing environment 103 may comprise, for example, a server computer or any other system providing computing capability. Alternatively, the computing environment 103 may employ multiple computing devices that may be arranged, for example, in one or more server banks, computer banks, or other arrangements. Such computing devices may be located in a single installation or may be distributed among many different geographical locations. For example, the computing environment 103 may include multiple computing devices that together form a hosted computing resource, a grid computing resource, and/or any other distributed computing arrangement. In some cases, the computing environment 103 may correspond to an elastic computing resource where the allotted capacity of processing, network, storage, or other computing-related resources may vary over time. The computing environment 103 may also include or correspond to one or more virtualized or containerized server instances that are created in order to execute the functionality that is described herein.

Various systems and/or other functionality may be executed in the computing environment 103 according to various embodiments. Also, various data is stored in a data store 116 that is accessible to the computing environment 103. The data store 116 may be representative of a plurality of data stores 116. The data stored in the data store 116, for example, is associated with the operation of the various systems and/or functional entities described below.

A device management system 119 and/or other systems may be executed in the computing environment 103. The device management system 119 may be executed to manage and/or oversee the operation of multiple client devices 106 (only one shown). For example, an employer may operate the device management system 119 to ensure that the client devices 106 of its employees are operating in compliance with various compliance rules. By ensuring that the client devices 106 of its employees are operated in compliance with the compliance rules, the employer may control and protect access to various data. The device management system 119 may also facilitate access to email, calendar data, contact information, documents, or other enterprise data to which an enterprise may wish to provide access by users via client devices 106.

In one embodiment, the device management system 119 may provide a management console 123, a license allocation application 126, and/or other components. The management console 123 may facilitate an administrator's operating and control of the device management system 119. For example, the management console 123 may generate one or more user interfaces that are rendered on a display device (not shown) or accessible via a browser executed by another computing device. Such user interfaces may facilitate entering commands or other information to facilitate configuration of the device management system 119. Additionally, the user interfaces may render presentations of statistics or other information regarding the client devices 106 that are managed by the device management system 119.

The computing environment 103 may also execute a license allocation application 126 that facilitates the obtaining of digital application licenses from an application distribution environment 109 as well as allocation of these licenses among user groups 118 within an enterprise and assignment of these licenses to specific users and/or client devices 106 within the enterprise. In some embodiments, the license allocation application 126 can communicate with the application distribution environment 109 via an application programming interface (API) (not shown) that is provided by the application distribution environment 109 in which API calls can be made via the network 113.

The computing environment 103 may also execute other applications to facilitate interactions with a client device 106, such as an application distribution service that distributes applications and/or updates for applications to the client device 106, a mail server that provides email services and/or functionality, a document storage application that provides remote document storage capability for users of an enterprise, or other applications or services that an enterprise may deploy to provide services for its users. Description of such applications or services is not necessary for a complete understanding of embodiments of the disclosure.

The data stored in the data store 116 may include user data 117 such as client device data 133, and user licenses 135, and/or other information such as user profile information (not shown). User profile information can include information about a user's role within an organization, an office address or location, home address or location, permissions, and/or privileges with respect to usage of an enterprise device. For example, certain users in an enterprise may be classified differently from other users. In this regard, users may be assigned to various user groups 118 within an enterprise. For example, a user group 118 may specify a worker role within a company (e.g., sales, marketing, human resources, etc.), a division within a company, a geographic location or corporate office of a company, a labor category within a company (e.g., executives, contractors, etc.), or any other attribute by which users may be grouped within an enterprise. Additionally, users may be assigned to more than one user group 118 within an enterprise.

User data 117 can also include access settings (not shown) such as authentication credentials, delegation settings (e.g., information about other users who may be provided access to the user data 117 of a particular user), mail and document retention rules and/or policies, and/or other geographic access restrictions or limitations (e.g., information about certain locations and/or networks from which user data 117 can be accessed). User data 117 can also include information about a user account within the computing environment 103, which is referred to herein as an enterprise user account. For example, the enterprise user account may be associated with an email address or other identifier that is assigned by the computing environment 103, which may be separate or different from a personal email address or other identifier that a user may use for personal purposes. User data 117 may further include information about a user account that a user may have within the application distribution environment 109, which is an account that is external to the enterprise account. Information about the user account within the application distribution environment 109 may comprise a hash of the user's account identifier within the application distribution environment 109 or another identifier from which the user's account within the application distribution environment 109 can be identified.

The client device data 133 may include information regarding the client devices 106 that are managed by the device management system 119. For example, client device data 133 may include a device identifier that uniquely identifies one or more client devices 106 that are associated the user's account in the enterprise. Such client device data 133 for a particular client device 106 may also include, for example, the identification of the particular applications 129 that are installed in the client device 106, historical data regarding the operation of the client device 106, and/or other information. User data 117 can also include information on licenses that a particular user has been assigned, or user licenses 135. A user license 135 can comprise a unique identifier associated with a particular digital application license that has been assigned to a user and/or a particular client device 106 associated with the user by the license allocation application 126.

For example, a user may request installation of a particular application 129 via the device management system 119 or via the application distribution environment 109 by an application executed by the client device 106, such as a client application executed by the client device 106. Such an application can allow the user to browse, purchase, and/or download application from the application distribution environment 109 using a user account within the application distribution environment 109 that is separate from an enterprise user account within the computing environment 103. In response to such a request, the license allocation application 126 can assign a user license 135 to the user account within the enterprise, giving the client device 106 permission or authorization to download and/or install a particular application 129 on a client device 106 and potentially multiple client devices 106 associated with a particular user account within the enterprise.

As another example, a systems administrator may designate, via the management console 123, that a particular application should be installed on a client device 106 of the user which can cause the device management system 119 to push a copy of the application 129 for installation on the client device 106 to the client device 106. In such a scenario, the license allocation application 126 can assign a user license 135 to the user by associating a license for the application 129 with the user data 117. Accordingly, the device management system 119 can initiate a download of the application 129 to the client device 106 upon a subsequent occurrence of the client device 106 being in communication with the computing environment 103. A user license 135 can also include a cost measure that associates a cost of the license. Such a cost measure can be utilized for cost tracking and/or internal budgeting purposes.

A license pool 139 associated with a user group 118 comprises a pool of digital application licenses obtained from the application distribution environment 109 that are allocated to a particular user group 118 within the enterprise. The license allocation application 126 can allocate licenses to the user group 118 from a larger set of licenses that are obtained for the entire enterprise. For example, a system administrator may specify that various user groups 118 are allocated varying numbers of licenses obtained from the application distribution environment 109 based upon a size of the user group 118, whether a particular user group 118 requires a particular application, or other factors that may be determined by a system administrator. In some embodiments, a particular user account within the computing environment 103 may be associated with more than one user group 118. Accordingly, a user group 118 may be assigned a optimality parameter such that, when determining from which user group 118 license pool 139 to obtain a license for assignment to a particular user, the license allocation application 126 can identify the optimal user group 118 to which a user is assigned that also has a license in its license pool 139 based at least in part on the optimality parameter.

The client device 106 is representative of multiple client devices that may be coupled to the network 113. The client device 106 may comprise, for example, a processor-based system such as a computer system. Such a computer system may be embodied in the form of a desktop computer, a laptop computer, a personal digital assistant, a mobile phone (e.g., a “smartphone”), a set-top box, a music player, a web pad, a tablet computer system, a game console, an electronic book reader, or any other device with like capability. The client device 106 may include a display that comprises, for example, one or more devices such as liquid crystal display (LCD) displays, gas plasma-based flat panel displays, organic light emitting diode (OLED) displays, LCD projectors or other types of display devices.

The client device 106 may be configured to execute one or more applications 129, an agent application 131, and/or other components. An application 129 may comprise, for example, one or more programs that perform various operations when executed in the client device 106. Such an operation may comprise, for example, storing data, reading data, controlling a component for the client device 106, and/or other functionality. An application 129 may perform some operations by initiating functions that are performed by an operating system in the client device 106. An application 129 may initiate operating system functions by, for example, performing API calls.

An application 129 may be obtained via the application distribution environment 109 and/or the device management system 119. As noted above, a user may be associated with a first user account within the application distribution environment 109 and a separate user account within the computing environment 103, which can be operated by an enterprise that is separate from an entity operating the application distribution environment 109. Accordingly, an application 129 executed by the client device 106 can be obtained from the application distribution environment 109 using the first user account.

The agent application 131 may be executed on the client device 106 to oversee, monitor, and/or manage at least a portion of the resources for the client device 106. The agent application 131 may be executed by the client device 106 automatically upon startup of the client device 106. Additionally, the agent application 131 may run as a background process in the client device 106. In other words, the agent application 131 may execute and/or run without user intervention. Additionally, the agent application 131 may communicate with the device management system 119 in order to facilitate the device management system 119 management of the client device 106. The agent application 131 can also facilitate distribution of digital application licenses on behalf of the license allocation application 126. In one embodiment, the agent application 131 can report application usage data to the license allocation application 126 as well as when or if a particular application is removed from a client device 106. In such a scenario, a license may be returned to a pool from which the license was obtained. Additionally, the agent application 131 can also facilitate installation of applications on the client device 106 when a license is granted to a particular client device 106 or a user associated with the client device 106. The agent application 131 can also determine whether a particular application for which a license is allocated to a user or a client device 106 is permitted to be installed based upon compliance of the client device 106 with compliance rules

The application distribution environment 109 may comprise, for example, a server computer or any other system providing computing capability. Alternatively, the application distribution environment 109 may employ multiple computing devices that may be arranged, for example, in one or more server banks, computer banks, or other arrangements. Such computing devices may be located in a single installation or may be distributed among many different geographical locations.

The application distribution environment 109 may provide an application repository 153 that stores various data related to the distribution and/or sale or application and other software via an electronic retail presence. In one embodiment, the application repository 153 can store user data 155, license data 157, application data 159 and other data. User data 155 may include information about users of the application distribution environment 109. As noted above, users of the application distribution environment 109 may be associated with a user account within the application distribution environment 109 that is separate from a user account associated with the enterprise or computing environment 103. Accordingly, the user data 155 can be configured to store user profile information, payment information, or other user profile data that is related to a user account of the user within the application distribution environment 109.

License data 157 represents data regarding licenses for applications 129 that are available via the application distribution environment 109. License data 157 can include digital application licenses that must accompany an application 129 that is distributed via the application distribution environment 109. License data 157 may also include a digital application license that must be used to sign an application 129 before it can be distributed to or installed on a client device 106. Additionally, license data 157 can also include data regarding pools of digital application licenses that are generated and issued to an enterprise for subsequent redistribution to users of the enterprise as they are needed for user installation and use of an application that is acquired on behalf of the enterprise users from the application distribution environment 109. For example, license data 157 can include an indication that a given number of licenses have been granted to a particular enterprise, such as via the license allocation application 126 executed by the computing environment 103. In some embodiments, license data 157 can include a key or alphanumeric code that is generated for each digital application license that is maintained by the application distribution environment 109 on behalf of an enterprise to which the digital application license is issued. The application distribution environment 109 can reduce a balance of the number of licenses associated with the enterprise upon receiving an indication via an API or other mechanism that one or more of the pool of licenses associated with the enterprise has been allocated to a user. License data 157 can also include a cost measure per license or pool or licenses. A digital application license can represent a right to download, install and/or use an application 129 obtained via the application distribution environment 109 on a client device 106 using a digital application license that is obtained by an enterprise on behalf of its users.

The application data 159 may comprise data representing several applications 129 that are made available for distribution to the client devices 106 and managed by the device management system 119, but also to the client devices 106 that are not managed by the device management system 119. The application data 159 may also include information that is associated with these applications 129, such binary packages or installers that may be installed upon and executed by the client device 106.

As noted above, the application distribution environment 109 can be configured to communicate with the license allocation application 126 or any other system via an API provided by the application distribution environment 109. In one embodiment, the license allocation application 126 can transmit an account identifier or a hashed value corresponding to an account identifier that corresponds to a user account within the application distribution environment 109 via such an API to the application distribution environment 109. The license allocation application 126 can also transmit to the application distribution environment 109 an indication that a user account within the application distribution environment 109 corresponding to such an account identifier has been issued a license for a particular application 129 from a license pool 139. In response to receiving such an indication, the application distribution environment 109 can initiate deployment of the application 129 to the client device 106 and/or indicate that the user does not require purchasing of an additional license in order to access the application 129 via the application distribution environment 109. For example, if the user browses a public electronic storefront of the application distribution environment 109 to locate a particular application 129 for which the user has been granted a license, the application distribution environment 109 can indicate that the user does not need to purchase the application in order to download or install the application because the user's account within the application distribution environment 109 has already been associated with permissions to download and/or install the application 129.

Next, an additional description of the operation of the various components of the networked environment 100 is provided. To begin, the device management system 119, via the license allocation application 126, can obtain a plurality of digital application licenses that correspond to a particular application 129 that is available via the application distribution environment 109. As noted above, the application distribution environment 109 can comprise a system that is operated and/or managed by an entity other than an enterprise operating the computing environment 103. For example, a hardware manufacturer or software maker may choose to distribute applications 129 for use upon client devices 106 of users through their own application distribution environment 109 rather than provide copies of an application 129 to an enterprise's information technology personnel, who then facilitate installation of applications 129 upon client devices 106 that correspond to its users.

In such a scenario, an application distribution environment 109 may still provide mechanisms by which an enterprise may manage the digital application licenses that correspond to applications 129 that are available via the application distribution environment 109 so that an enterprise can provide applications 129 that the enterprise deems necessary, useful or desirable by their users. Therefore, the license allocation application 126 can be configured to obtain or request a plurality of digital application licenses from the application distribution environment 109 via an API call or other mechanism. In response to receiving such a request, the application distribution environment 109 can transmit a number of requested licenses to the license allocation application 126 (e.g., product keys, license keys or other digital licenses, etc.), which can store the license in the data store 116 or other storage. Alternatively, the application distribution environment 109 can transmit a confirmation that the number of requested licenses has been allocated to the enterprise in the license data 157 housed in the application repository 153.

Accordingly, a system administrator can allocate licenses obtained via the application distribution environment 109 to various user groups 118 within the enterprise via the license allocation application 126. In other words, the licenses obtained from the application distribution environment 109 can be assigned to various license pools 139 of various user groups 118 within the enterprise. Such allocation can be carried out by an examination of a number of users with the various groups, whether a particular user group 118 requires a particular application based upon an attribute of the user group 118 such as location, labor category, role within the enterprise, size of the group, or other attributes. For example, a system administrator can assign a license for a particular sales-focused application 129 to every member of a sales group but not assign the same licenses for the application 129 to a user group 118 that is associated with a human resources role within the enterprise. Additionally, a system administrator may wish to assign a certain number of licenses from the plurality of licenses obtained from the application distribution environment 109 to a license pool 139 that is less than a number of users in a corresponding user group 118 to account for a scenario in which not all users from the user group 118 may actually require a particular application 129. Alternatively, a system administrator may wish to designate a particular application 129 as a required application, which can cause the license allocation application 126 to assign every user in a user group 118 a user license 135.

As noted above, a user account may be associated with multiple user groups 118. Accordingly, a user group 118 may be assigned a priority such that, when determining from which user group 118 license pool 139 to obtain a license for assignment to a particular user, the license allocation application 126 can identify the highest priority user group 118 to which a user is assigned that also has a license in its license pool 139. In other scenarios or embodiments, a license may be selected based upon which user group 118 to which a user account belongs that has the greatest number of licenses in the license pool 139 associated with the user group 118. In other words, the user group 118 from which a license is obtained for a particular user can be determined based on consideration of one or more optimality parameters as described above.

When a license is associated with a particular user account, a balance of licenses remaining in the license pool 139 from which the license was obtained is reduced or decremented. Additionally, in the event that licenses of a particular enterprise are maintained by the application distribution environment 109 as license data 157, the license allocation application 126 can also transmit an API call to the application distribution environment 109 instructing the application distribution environment 109 to reduce a balance of licenses of a particular application 129 that are associated with an enterprise.

In certain scenarios, a license may not be available for a particular user from the various user groups 118 to which the user belongs. Accordingly, in such a scenario, the license allocation application 126 can generate a notification that is transmitted to an administrator that additional licenses for a particular application 129 may be needed and/or a particular user group 118 may need additional licenses allocated for members of the user group 118. In some embodiments, an “overflow” user group 118 can be established that is allocated licenses for assignment to a user in the event that the user does not belong to a user group 118 that is allocated a license for an application 129. In some scenarios, the license allocation application 126 can initiate automatic purchase of additional licenses for a particular application 129 from the application distribution environment 109 in the event that a particular user group 118 has exhausted its allocation of licenses.

In order to facilitate the ability of a user to obtain applications 129 from the application distribution environment 109 that are licensed under licenses allocated to the user via the license allocation application 126, a user may be required to enroll in a volume purchasing program or other type of program provided by the application distribution environment 109 that facilitates external enterprise management of or visibility into application licensing external to the application distribution environment 109. Accordingly, the device management system 119 can provide an enrollment workflow that allows the user to enroll a particular client device 106 with the device management system 119 as well as the application distribution environment 109. Such a workflow can require the user to provide an account identifier (or a hash thereof) of a user account belonging to the user within the application distribution environment 109 as well as an account identifier of a user account of the user within the computing environment 103. Such a workflow may also create a linkage within the client device data 133 corresponding to the user between the user account within the application distribution environment 109 and the user account within the computing environment 103.

Accordingly, assigning a user license 135 to a particular user by the license allocation application 126 can cause the application 129 to be pushed to the client device 106 from the application distribution environment 109 in response to an indication from the license allocation application 126 that the user has been assigned a license for the application 129 from a license pool 139 containing licenses obtained by the enterprise. Such an indication from the license allocation application 126 can identify the application 129 and/or a license corresponding to the application 129 as well as an account identifier, or a hash value corresponding to the account identifier, of a user account associated with the user within the application distribution environment 109. In this way, a license is allocated to the user as a user license 135. Such a license is also associated with the user account within the computing environment 103 via the user data 117 corresponding to such an account.

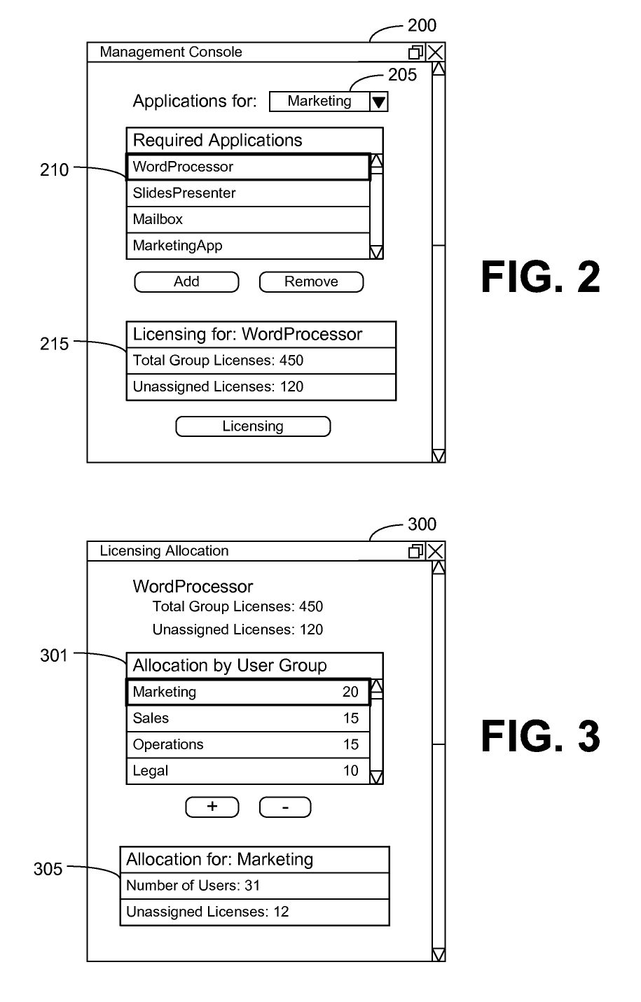

Referring next to FIG. 2, shown is a user interface 200 that can be generated by the management console 123 or any other system or module associated with the device management system 119. The user interface 200 shown in FIG. 2 represents merely one non-limiting example that is depicted for illustrative purposes. In the user interface 200 of FIG. 2, a system administrator can specify applications in user interface portion 210 that are associated with a particular user group 118, shown at user interface portion 205, as potentially being required by users of the user group 118. Additionally, the user interface 200 can also depict, at user interface portion 215, information about a license pool 139 corresponding to the user group 118 selected and highlighted in user interface portion 210 so that a system administrator may allocate and/or remove licenses to or from the license pool 139 depending upon usage of the licenses in the license pool 139.

Referring next to FIG. 3, shown is a user interface 300 that can be generated by the license allocation application 126 or any other system or module associated with the device management system 119. The user interface 300 shown in FIG. 3 represents merely one non-limiting example that is depicted for illustrative purposes. In the user interface 300 of FIG. 3, information regarding the allocation of licenses for an application 129 among the various user groups 118 within an enterprise is presented at user interface portion 301. As shown in FIG. 3, a network administrator can adjust the size of a license pool 139 associated with a user group 118 at user interface portion 301, and from the adjusted license pool 139, the license allocation application 126 can assign a user license 135 to a client device 106 associated with a user. The user interface 300 further depicts an allocation of licenses at user interface portion 305 for a particular user group 118.

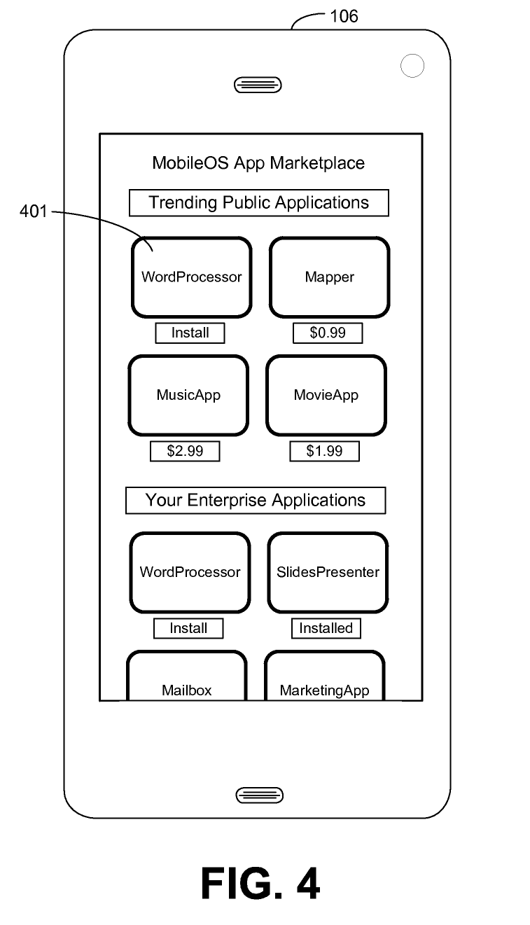

Reference is now made to FIG. 4, which illustrates an example user interface that can be rendered by a client device 106 according to various embodiments of the disclosure. The example of FIG. 4 illustrates a user interface that corresponds to an application marketplace client, or an application store, that is associated with the application distribution environment 109. In the example of FIG. 4, applications 129 that are available via the application distribution environment 109 can be displayed so that a user may purchase or download the applications 129. As shown in FIG. 4, a license for a particular application 401 has been assigned by the license allocation application 126 to the user. Accordingly, the application marketplace can indicate that the user is authorized to download the application. Additionally, the application marketplace can also indicate applications for which licenses have been issued by the user's enterprise separate from other applications 129 that may be available via the application marketplace.

In this way, the application marketplace can include an enterprise portal that shows the various applications for which licenses have been provided or are available via the license allocation application 126 for a user of the enterprise. In some embodiments, a license can be provided by the user's enterprise upon registration of a user with a particular user group 118. In other embodiments, a license for a particular application 129 may be assigned to the user via the license allocation application 126 only after the user attempts to install the application 129 via the application distribution environment 109.

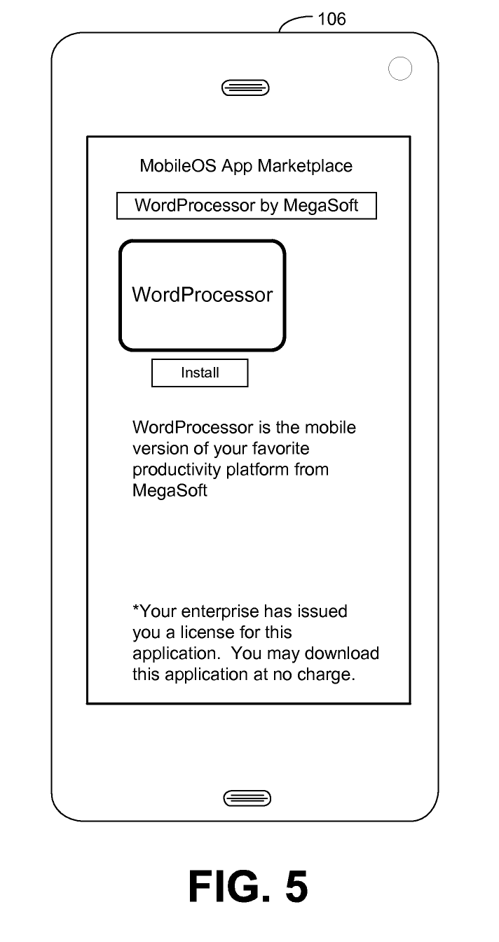

Continuing the example of FIG. 4, reference is now made to FIG. 5, which illustrates an example of an alternative user interface rendered in a client device 106 that can be associated with the application distribution environment 109. In the example of FIG. 5, details regarding a particular application 401 are displayed along with an indication that a license for the particular application 401 has been obtained for or made available to the user by an enterprise on behalf of the user as described above.

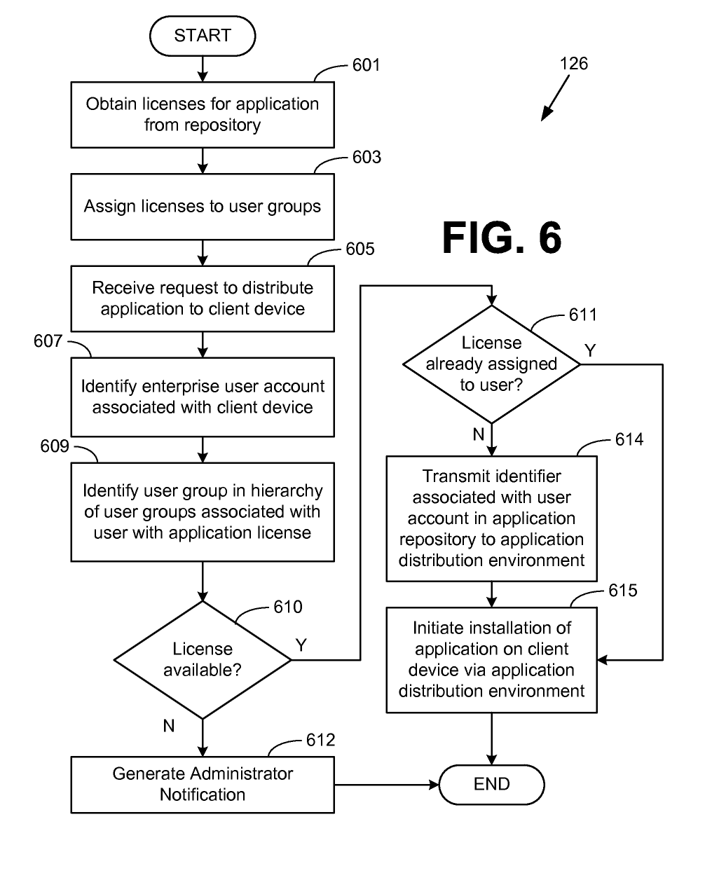

Referring next to FIG. 6, shown is a flowchart that provides one example of the operation of a portion of the license allocation application 126 according to various embodiments. It is understood that the flowchart of FIG. 6 provides merely an example of the many different types of functional arrangements that may be employed to implement the operation of the portion of the license allocation application 126 as described herein. As an alternative, the flowchart of FIG. 6 may be viewed as depicting an example of elements of a method implemented in the client device 106 (FIG. 1) according to one or more embodiments.

Beginning with box 601, the license allocation application 126 can obtain licenses for a particular application 129 from an application repository 153 via the application distribution environment 109. As noted above, the license allocation application 126 can obtain multiple licenses that it may later assign to users of the computing environment 103 so that the enterprise users may install the particular application 129 on client devices associated with the user. At box 603, the license allocation application 126 can assign the licenses obtained from the application distribution environment 109 to various users groups 118 within the enterprise. At box 605, the license allocation application 126 can receive a request to distribute an application to a client device 106. Such a request can be obtained from a user wishing to enroll a device with the device management system 119 or install a particular application 129 on a client device, or a request can be obtained from a system administrator indicating that a particular application 129 should be installed on a user's client device 106.

At box 607, the license allocation application 126 can identify an enterprise user account, or an account within the computing environment 103, that is associated with the client device 106. The license allocation application 126 can identify the enterprise user account by analyzing a device identifier associated with the client device 106. The license allocation application 126 may also obtain an account identifier, such as a user's username, email address, or other identifier, from the user and identify an account within the computing environment 103 that corresponds to the account identifier. Next, at box 609, the license allocation application 126 can identify a user group 118 from among various group memberships in a hierarchy of group memberships of a user or user account that has a license in its license pool 139 for the application 129. In other words, the license allocation application 126 can identify a first user group in an ordered hierarchy of groups of which the user is a member that is allocated a particular license for the application. In some embodiments, a license can be obtained from a lowest group in hierarchy of groups of which the user is a member. For example, a user may assign a priority to user groups within an enterprise that defines a priority or ranking to the user group that the license allocation application 126 can consult to identify a particular user group from which a license should be assigned to a user.

In other words, as noted above, the user group 118 from which a license is obtained can be determined based upon an optimality parameter determined based upon consideration of the various group memberships of a particular user account, a number of licenses available in a particular license pool 139, a number of users in a particular user group 118 relative to the number of licenses available in a license pool 139, or other factors as described herein. At box 610, the license allocation application 126 can determine whether a license from the various group memberships of the user is available. If no user license 135 for the requested application 129 from a license pool 139 associated with the user's various group memberships has a license available for the requested application 129, then the license allocation application 126 can proceed to box 612, where the license allocation application 126 can generate an administrator notification so that an administrator can obtain additional licenses for the application 129. In some embodiments, the license allocation 126 can also initiate automatic purchase or procurement of additional licenses via the application distribution environment 109 and proceed to box 614.

At box 611, the license allocation application 126 determines whether a user license 135 for the requested application 129 is already assigned to the user. For example, a user may have installed the application 129 on another client device 106, such as a smartphone, but may not require an additional license in order to install the application 129 on a second client device 106, such as a tablet device. Accordingly, if a user license 135 for the requested application 129 is already assigned to the user, then at box 615, the license allocation application 126 initiates installation or deployment of the application to the client device 106 via the application distribution environment 109 without assigning the user a license from a user group within the enterprise.

If a license has not already been assigned to the user, then at box 614, the license allocation application 126 transmits an identifier associated with the user's account within the application distribution environment 109 so that the application distribution environment 109 can associate the user's account with a license or permission to obtain, install or otherwise use the application 129. At box 615, the license allocation application 126 initiates installation or deployment of the application to the client device 106 via the application distribution environment 109.

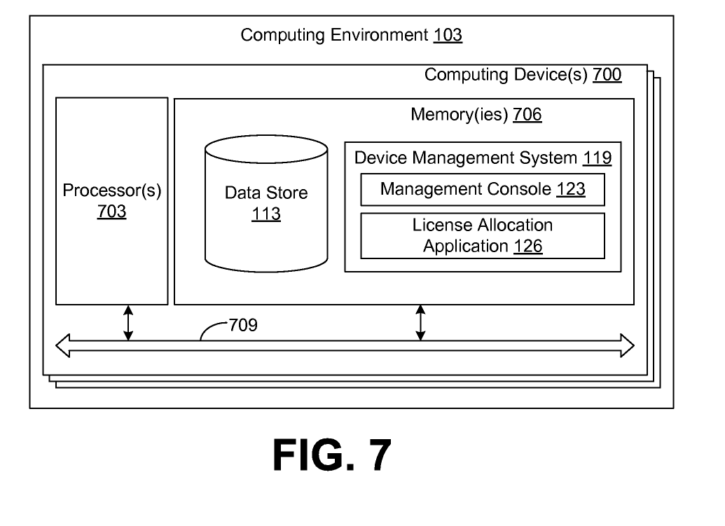

With reference to FIG. 7, shown is a schematic block diagram of the computing environment 103 according to an embodiment of the described system. The computing environment 103 includes one or more computing devices 700. Each computing device 700 includes at least one processor circuit, for example, having a processor 703 and a memory 706, both of which are coupled to a local interface 709. As such, each computing device 700 may comprise, for example, at least one server computer or like device. The local interface 709 may comprise, for example, a data bus with an accompanying address/control bus or other bus structure as can be appreciated.

Stored in the memory 706 are both data and several components that are executable by the processor 703. In particular, stored in the memory 706 and executable by the processor 703 are the remote mail server 115, and potentially other applications. Also stored in the memory 706 may be a data store 116 and other data. In addition, an operating system may be stored in the memory 706 and executable by the processor 703.

It is understood that there may be other applications that are stored in the memory 706 and are executable by the processor 703 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 706 and are executable by the processor 703. In this respect, the term “executable” means a program file that is in a form that can ultimately be run by the processor 703. Examples of executable programs may be, for example, a compiled program that can be translated into machine code in a format that can be loaded into a random access portion of the memory 706 and run by the processor 703, source code that may be expressed in proper format such as object code that is capable of being loaded into a random access portion of the memory 706 and executed by the processor 703, or source code that may be interpreted by another executable program to generate instructions in a random access portion of the memory 706 to be executed by the processor 703, etc. An executable program may be stored in any portion or component of the memory 706 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 706 is defined herein as including both volatile and nonvolatile memory and data storage components. Volatile components are those that do not retain data values upon loss of power. Nonvolatile components are those that retain data upon a loss of power. Thus, the memory 706 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 703 may represent multiple processors 703 and/or multiple processor cores and the memory 706 may represent multiple memories 706 that operate in parallel processing circuits, respectively. In such a case, the local interface 709 may be an appropriate network that facilitates communication between any two of the multiple processors 703, between any processor 703 and any of the memories 706, or between any two of the memories 706, etc. The local interface 709 may comprise additional systems designed to coordinate this communication, including, for example, performing load balancing. The processor 703 may be of electrical or of some other available construction.

Although the device management system 119, management console 123, license allocation application 126, and other various systems described herein may be embodied in software or code executed by general purpose hardware as discussed above, as an alternative, the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 6 shows an example of the functionality and operation of an implementation of portions of the license allocation application 126. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 703 in a computer system or other system. The machine code may be converted from the source code, etc. If embodied in hardware, each block may represent a circuit or a number of interconnected circuits to implement the specified logical function(s).

Although the flowchart of FIG. 6 shows a specific order of execution, it is understood that the order of execution may differ from that which is depicted. For example, the order of execution of two or more blocks may be scrambled relative to the order shown. Also, two or more successive blocks shown in FIG. 6 may be executed concurrently or with partial concurrence. Further, in some embodiments, one or more of the blocks shown in FIG. 6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the license allocation application 126, that comprises software or code can be embodied in any non-transitory computer-readable medium for use by or in connection with an instruction execution system such as, for example, a processor 703 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM), dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the license allocation application 126, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 700 and/or client device 106, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It is emphasized that the above-described embodiments of the present disclosure are merely possible examples of implementations set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by the following claims.

Therefore, the following is claimed:

1. A non-transitory computer-readable medium embodying program code executable in a computing device, the program code being configured to cause the computing device to at least:
allocate a plurality of digital application licenses associated with a particular application among a plurality of groups of users within an enterprise, wherein the plurality of digital application licenses are obtained from an application repository and the plurality of digital application licenses are stored by an application distribution environment associated with the application repository;
obtain a request to distribute the particular application to a client device associated with a user associated with one of the plurality of groups of users;
determine whether the user has been previously assigned a first digital application license for the particular application;
in response to determining that the user has not been previously assigned the first digital application license for the particular application, identify, based at least in part upon an assignment of the plurality of licenses among the plurality of groups, at least one of the plurality of groups having a non-zero balance of unassigned licenses from the plurality of digital application licenses, wherein the user is a member of the at least one of the plurality of groups;
identify one of the at least one of the plurality of groups from which to assign the user one of the plurality of digital application licenses based upon a priority of group memberships of the user;
assign the user the one of the plurality of digital application licenses; and
reduce the balance of unassigned licenses of the plurality of digital application licenses from the one of the at least one of the plurality of groups.

2. The non-transitory computer-readable medium of claim 1, wherein the one of the at least one of the plurality of groups is identified based at least in part upon a number of unassigned licenses associated with the at least one of the plurality of groups.

3. The non-transitory computer-readable medium of claim 1, wherein the one of the at least one of the plurality of groups is identified based at least in part upon an optimality parameter associated with the at least one of the plurality of groups.

4. The non-transitory computer-readable medium of claim 3, wherein the optimality parameter comprises at least one of: the priority, a cost, or an order of the group memberships of the user.

5. The non-transitory computer-readable medium of claim 4, wherein a user account corresponding to the user is identified via a hash of an account identifier within the application repository.

6. The non-transitory computer-readable medium of claim 1, wherein the program code is further configured to cause the computing device to at least:
determine based at least upon a status indicator associated with the client device in a data store accessible to the computing device whether another client device is associated with the user; and
initiate installation of the application without assigning the user another of the plurality of digital application licenses.

7. A system, comprising:
at least one computing device;
programming code executable in the at least one computing device, the programming code being configured to cause the at least one computing device to at least:
obtain a plurality of digital application licenses associated with an application in an application repository;
obtain a request to initiate deployment of the application to a client device of a user, the user being associated with a first user account in the application repository and a second user account external to the application repository, the first user account and the second user account being associated with one another in a data store accessible to the at least one computing device;
determine whether the first user account in the application repository is associated with a digital application license corresponding to the application;
in response to determining that the first user account in the application repository is not associated with the digital application license, identify, based upon a plurality of group memberships of the second user account external to the application repository, a user group associated with a balance of digital application licenses corresponding to the application based at least upon a priority of the respective ones of the plurality of group memberships;
associate the first user account and the second user account with one of the plurality of digital application licenses from the user group; and
initiate, via the application repository, installation of the application on the client device.

8. The system of claim 7, wherein the second user account is associated with at least one of a plurality of user groups in an enterprise system external to the application repository.

9. The system of claim 8, wherein the plurality of digital application licenses are distributed among the plurality of groups of users in the enterprise system.

10. The system of claim 7, wherein the first user account and the second user account are associated with one of the plurality of digital application licenses by:
identifying one of the plurality of groups of users associated with the second user account that is also associated with at least one digital application license being distributed from the plurality of digital application licenses; and
associating one of the plurality of digital application licenses to the first user account and the second user account.

11. The system of claim 10, wherein the second user account is associated with multiple ones of the plurality of groups of users and identifying one of the at least one plurality of groups of users associated with the second user account that is also associated with at least one digital application license further comprises:
selecting one of the multiple ones of the plurality of groups of users based at least in part upon a priority associated with each of the multiple ones of the plurality of groups of users.

12. The system of claim 10, wherein associating the one of the plurality of digital application licenses further comprises initiating an application programming interface (API) command provided by the application repository, the API command associating the one of the plurality of digital application licenses to the first user account in the application repository, wherein the API command further decrements a quantity of the plurality of digital application licenses in the application repository.

13. The system of claim 10, wherein associating the one of the plurality of digital application licenses further comprises generating an indication in the data store that the second user account is associated with the one of the plurality of digital application licenses.

14. The system of claim 13, wherein the programming code is further configured to:
obtain a request to initiate deployment of the application to a second client device associated with the second user account; and
initiate installation of the application on the second client device without associating the first user account and the second user account with another one of the plurality of digital application licenses.

15. A method, comprising:
obtaining, using at least one computing device, a plurality of digital application licenses associated with an application from a third-party application repository;
receiving, in the at least one computing device, a request to install the application on a client device associated with a user, the user being associated with a first user account in the third-party application repository and a second user account associated with the at least one computing device;
in response to a determination that the first user account in the third-party application repository is not associated with a digital application license corresponding to the application, identifying, based upon a plurality of group memberships of the second user account associated with the at least one computing device, a user group associated with a balance of digital application licenses corresponding to the application based at least upon a priority of the respective ones of the plurality of group memberships;
associating, via the at least one computing device, one of the plurality of digital application licenses from the user group with the first user account, the second user account, and the client device; and
initiating, by the at least one computing device, installation of the application via the third-party application repository on the client device.

16. The method of claim 15, wherein the request to install the application on the client device is obtained from the client device via a user interface generated by the third-party application repository.

17. The method of claim 15, wherein the request to install the application on the client device is obtained from the client device via an enterprise portal generated by the third-party application repository, the enterprise portal being associated with an enterprise associated with the second user account.

18. The method of claim 15, wherein the request to install the application on the client device is obtained from an administrator associated with an enterprise associated with the second user account.

19. The method of claim 18, wherein the installation of the application is pushed to the client device without a user intervention of the user.

20. The method of claim 15, wherein the plurality of digital application licenses are allocated to an enterprise account associated with a plurality of users.

21. The method of claim 20, wherein the plurality of digital application licenses are stored within the third-party application repository.
